(19) United States
(12) Patent Application Publication
(10) Pub. No.: US 2006/0034536 A1
(43) Pub. Date: Feb. 16, 2006

(54) Systems and methods relating to magnitude enhancement analysis suitable for high bit level displays on low bit level systems, determining the material thickness, and 3D visualization of color space dimensions

(76) Inventors: Wayne E. Ogren, Bellingham, WA (US); Patrick B. Love, Bellingham, WA (US); Peter B. McLain, Bellingham, WA (US); Rick Mancilla, Ventura, CA (US); Edward Steiner, Owings Mills, MD (US); William Paul Rogers, Bellingham, WA (US); Andrew Haring, Kirkland, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/165,824

(22) Filed: Jun. 23, 2005

Related U.S. Application Data
(60) Provisional application No. 60/582,414, filed on Jun. 23, 2004.
(60) Provisional application No. 60/585,059, filed on Jul. 2, 2004.
(60) Provisional application No. 60/604,092, filed on Aug. 23, 2004.
(60) Provisional application No. 60/618,276, filed on Oct. 12, 2004.
(60) Provisional application No. 60/630,824, filed on Nov. 23, 2004.
(60) Provisional application No. 60/665,967, filed on Mar. 28, 2005.

(51) Int. Cl. G06K 9/40; G06T 17/00

(52) U.S. Cl. 382/254; 345/428

(57) ABSTRACT

Systems and methods, etc., comprising magnitude enhancement analysis configured to display intensity-related features of high-bit images, such as grayscale, on low-bit display systems, without distorting the underlying intensity unless desired, measuring the thickness of materials, and/or enhancing perception of saturation, hue, color channels and other space dimensions in a digital image, and external datasets related to a 2d image. These various aspects and embodiments provide improve systems and approaches to display and analyze, particularly through the human eye (HVS).

### CROSS-REFERENCE TO RELATED APPLICATIONS

The present application claims priority from U.S. provisional patent application No. 60/582,414, filed Jun. 23, 2004; U.S. provisional patent application No. 60/585,059 filed Jul. 2, 2004; U.S. provisional patent application No. 60/604,092 filed Aug. 23, 2004; U.S. provisional patent application No. 60/618,276 filed Oct. 12, 2004; U.S. provisional patent application No. 60/630,824 filed Nov. 23, 2004; and, U.S. provisional patent application No. 60/665,967 filed Mar. 28, 2005, which are incorporated herein by reference in their entirety and for all their teachings and disclosures.

### BACKGROUND

The human eye and brain, or human visual system (HVS), helps people prosper in a competitive race for survival. Use of the HVS as a tool for analytical purposes such as medical or industrial radiography, is a fairly recent use of the HVS.

Visual observation of lightness or darkness (“grayscale”) of items in an image or scene is a prominent method to identify items in the image, which items can be important, for example, to medical diagnosis and treatment, or industrial quality control, or other image-critical decision making processes. Other fields using observation of grayscale values include forensic, remote surveillance and geospatial, astronomy, geotechnical exploration, and others. These observation processes provide an important improvement to our overall health, safety, and welfare.

HVS perception of changes in grayscale tonal values (and other intensity values) is variable, affected by multiple factors. “Just noticeable difference—JND” identifies HVS ability to distinguish minor differences of grayscale intensity for side-by-side samples, and is also known as the Weber Ratio. A simple thought experiment exemplifies the variability of HVS perception, in this case, the variation of JND with overall luminance level. Consider sunrise; as dawn approaches, the pitch blackness reveals more detail of the surrounding scene to the HVS (discriminate more shades of gray) as the sun increases the scene illumination. This occurs even while adaptive discrimination of HVS (night vision) has adequate time to adjust our perception skills to the low illumination level at night.

The JND variability is quantified in DICOM Part 14 (FIG. 2): Grayscale Standard Display Function. For medical radiography, electronic image processing is standardized per DICOM Part 14 to portray up to 1000 JND grayshades. The HVS may be able to perceive as many as 1,000 tonal grayshades under properly controlled observation conditions, but as a topographic surface, the perception task is relieved of this need for sophisticated methods.

LumenIQ, Inc. (“Lumen”) has numerous patents and published patent applications that discuss methods, systems, etc., of using 3D visualization to improve a person's ability to see small differences in an image, such as small differences in the lightness or darkness (grayscale data) of a particular spot in a digital image. U.S. Pat. No. 6,445,820; U.S. Pat. No. 6,654,490; U.S. 20020114508; WO 02/17232; 20020176619; 20040096098; 20040109608. Generally, these methods and systems display grayscale (or other desired intensity, etc.) data of a 2D digital image as a 3D topographic map: The relative darkness and lightness of the spots (pixels) in the image are determined, then the darker areas are shown as “mountains,” while lighter areas are shown as “valleys” (or vice-versa). In other words, at each pixel point in an image, grayscale values are measured, projected as a surface height (or z axis), and connected through image processing techniques. FIGS. 1A and 1B show examples of this, where the relative darkness of the ink of two handwriting samples are shown in 3d with the darker areas shown as higher “mountains.”

This helps the human visual system (HVS) to overcome its inherent weakness at discerning subtle differences in image intensity patterns in a 2D image. If desired, the image can then be identified, rotated, flipped, tilted, etc. Such images can be referred to as magnitude enhancement analysis images, although the kinematic (motion) aspect need only be present when desired (in which case the created representations are not truly kinematic images). These techniques can be used with any desired image, such as handwriting samples, fingerprints, DNA patterns (“smears”), medical images such as MRIs, x-rays, industrial images, satellite images, etc.

There has gone unmet a need for improved systems and methods, etc., for interpreting and/or automating the analysis of images such as medical images. The present systems and methods provide these or other advantages.

### SUMMARY

In one aspect, the methods, systems, etc., discussed herein bypass the limitations of both display restrictions and HVS perception, portraying high bit level (9 or more bits) grayscale data (or other intensity date) as a 3-dimensional object using 8 bit display devices, and helping unaided HVS perception skills. With 3D surface or object display, human perception and image display grayscale limitations can be reduced, allowing display of an unlimited number of grayscale (and other) intensities.

In another aspect, the methods and systems herein comprise analyzing industrial radiography (NDE) radiographs (or other scans, typically transmissive scans) with an analysis system able to distinguish very fine levels of grayness (image intensity), and correlating the image intensity to the actual thickness of the underlying material. If desired, a thickness calibration function in the software can provide a 3D surface object that accurately matches the actual thickness of material in the 2D radiograph image. This allows rapid, interactive determination and visualization of material thickness. Other items can also be used to designate thickness variations, such as false-color representations. Multiple thickness-variation symbologies can be used simultaneously or in combination if desired.

Turning to another aspect, digital images have an associated color space that defines how the encoded values for each pixel are to be visually interpreted. Common color spaces are RGB, which stands for the standard red, green and blue channels for some color images and HSI, which stands for hue, saturation, intensity for other color images. The values of pixels measured along a single dimension or selected dimensions of the image color space to generate a surface map that correlates pixel value to surface height can be applied to color space dimensions beyond image intensity. For example, the methods and systems herein, including software, can measure the red dimension (or channel) in an RGB color space, on a pixel-by-pixel basis, and generate a surface map that projects the relative values of the pixels. In another example, the present innovation can measure image hue at each pixel point, and project the values as a surface height.

Further, the height of a gridpoint on the z axis can be calculated using any function of the 2D data set representing the image or related in some meaningful way to the image. A function to change information from the 2D data set to a z height may take the form f(x, y, pixel value)=z. All of the color space dimensions can be of this form, but there can be other values as well. For example, a function can be created in software that maps z height based on (i) a lookup table to a Hounsfield unit (f(pixelValue)=Hounsfield value), (ii) just on the 2D coordinates (e.g., f(x,y)=2x+y), (iii) any other field variable that may be stored external to the image, (iv) area operators in a 2D image, such as Gaussian blur values, or Sobel edge detector values, or (v) multi-modality data sets where one image is from an imaging modality (such as MR or CT) and a matched or registered image from another imaging modality (such as PET or Nuclear Medicine). In certain embodiments, the gray scale at each grid point is derived from the first image, and the height is derived from the second image.

As an example, the software, etc., can contain a function g that maps a pixel in the 2D image to some other external variable (for example, Hounsfield units) and that value can then be used as the value for the z height (with optional adjustment). The end result is a 3D topographic map of the Hounsfield units contained in the 2D image; the 3D map would be projected on the 2D image itself.

In one aspect, the present discussion includes methods of displaying a high bit level image on a low bit level display system. The methods can comprise: a) providing an at least 2-dimensional high bit level digital image; b) subjecting the high bit level image to magnitude enhancement analysis such that at least one relative magnitude across at least a substantial portion of the print can be depicted in an additional dimension relative to the at least 2-dimensions to provide a magnitude enhanced image such that additional levels of magnitudes can be substantially more cognizable to a human eye compared to the 2-dimensional image without the magnitude enhancement analysis; c) displaying a selected portion of the enhanced image on a display can comprise a low bit level display system having a bit level display capability less than the bit level of the high bit level image; and, d) providing a moveable window configured to display the selected portion such that the window can move the selected portion among an overall range of the bit level information in the high bit level image.

In some embodiments, the selected portion can comprise at least one bit level less information than the bit level of the high bit level image, and the high bit level image can be at least a 9 bit level image and the display system can be no more than an 8 bit level display system. The high bit level image can be a 16 bit level image and the display system can be no more than an 8 bit level display system. The image can be a can be a digital conversion of a photographic image, and the magnitude can be grayscale, and/or comprise at least one of hue, lightness, or saturation or a combination thereof. The magnitude can comprise an average intensity defined by an area operator centered on a pixel within the image, and can be determined using a linear or non-linear function.

The magnitude enhancement analysis can be a dynamic magnitude enhancement analysis, which can comprise at least one of rolling, tilting or panning the image, and can comprise incorporating the dynamic analysis into a cine loop.

In another aspect, the discussion herein includes methods of determining and visualizing a thickness of a sample. This can comprise: a) providing an at least 2-dimensional transmissive digital image of the sample; b) subjecting the image to magnitude enhancement analysis such that at least one relative magnitude across at least a substantial portion of the print can be depicted in an additional dimension relative to the at least 2-dimensions to provide a magnitude enhanced image such that additional levels of magnitudes can be substantially more cognizable to a human eye compared to the 2-dimensional image without the magnitude enhancement analysis; and c) comparing the magnitude enhanced image to a standard configured to indicate thickness of the sample, and therefrom determining the thickness of the sample.

In some embodiments, the methods further can comprise obtaining the at least 2-dimensional transmissive digital image of the sample. The standard can be a thickness reference block, and the sample can be substantially homogenous. The thickness reference block and the sample can be of identical material, the thickness reference block can have thickness values to provide intermediate thickness values with respect to the object of interest, and can be located substantially adjacent to each other.

In another aspect, the discussion herein includes methods of displaying a color space dimension, comprising: a) providing an at least 2-dimensional digital image comprising a plurality of color space dimensions; b) subjecting the 2-dimensional digital image to magnitude enhancement analysis such that a relative magnitude for at least one color space dimension but less than all color space dimensions of the image is depicted in an additional dimension relative to the at least 2-dimensions to provide a magnitude enhanced image such that additional levels of magnitudes of the color space dimension are substantially more cognizable to a human eye compared to the 2-dimensional image without the magnitude enhancement analysis; c) displaying at least a selected portion of the magnitude enhanced image on a display; and, d) analyzing the magnitude enhanced image to determine at least one feature of the color space dimension that would not have been cognizable to a human eye without the magnitude enhancement analysis.

In some embodiments, the methods further comprise determining an optical density of at least one object in the image, such as breast tissue. The magnitude enhancement analysis is a dynamic magnitude enhancement analysis, and can comprise, if desired, dynamic analysis comprising at least rolling, tilting and panning the image.

In another aspect, the discussion herein includes computer-implemented programming that performs the automated elements of any of the methods herein, as well as computers comprising such computer-implemented programming. The computer can comprise a distributed network of linked computers, can comprise a handheld and/or wireless computer. The systems can also comprise a networked computer system comprising computer-implemented programming as above. The networked computer system can comprise a handheld wireless computer, and the methods can be implemented on the handheld wireless computer. The systems can also comprise a networked computer system comprising a computer as discussed herein.

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIGS. 1A and 1B show examples of magnitude enhancement analysis processing of two handwriting samples with the darker areas shown as higher “mountains.”

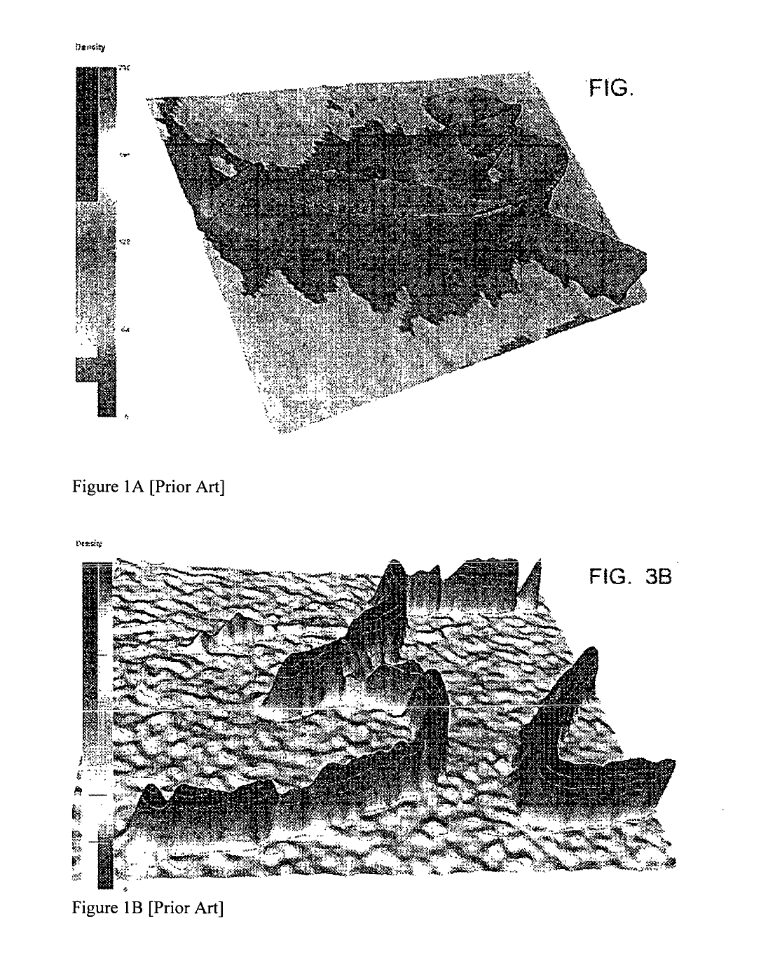

FIG. 2 schematically depicts image perception as a system of scene, capture, processing, display, and observation processes.

FIG. 3 schematically depicts an application of image perception processes for diagnostic and analytical decision making purposes improved by use of 3D surface mapping of image intensity data

FIG. 4 schematically depicts interactive transformation of grayscale intensity to elevation using a Kodak grayscale. The 3D surface image in the lower panel uses pseudocolor and perspective view in addition to mapping grayscale intensity to the z-axis. High bit level grayscale tonal information can thus be represented independent of human grayscale and display limitations.

FIG. 5 schematically depicts a TG18-PQC test pattern for comparison of printed film and electronic display luminance conventional (left) and intensity surface display (right), no contrast adjustment.

FIG. 6 schematically depicts a TG18-PQC test pattern for comparison of printed film and electronic display luminance conventional (left) and intensity surface display (right), with contrast adjustment.

FIG. 7 schematically depicts a TG18-pqc test pattern for comparison of printed film and electronic display luminance magnitude enhancement analysis view of 3D surface, 65,536 grayscale Z-axis. 3D surface image is composed of grayscale intensities 0 to 4096. Full range display identifies the grayscale intensity region of interest.

FIG. 8 schematically depicts a TG18-PQC test pattern for comparison of printed film and electronic display luminance magnitude enhancement analysis view of 3D surface showing 65,536 grayscale Z-axis clipped to display grayscales 0 to 4096. Clipping of the Z-axis need not alter any of the grayscale data values or their contrast relationships.

FIG. 9 depicts a screen capture of a computer-implemented system providing magnitude enhancement analysis and able to determine thickness values to provide intermediate thickness values with respect to an object of interest.

FIG. 10 depicts a further screen capture of a computer-implemented system as in FIG. 9.

FIG. 11 depicts a further screen capture of a computer-implemented system as in FIG. 9.

FIG. 12 depicts a further screen capture of a computer-implemented system as in FIG. 9.

FIG. 13 depicts a further screen capture of a computer-implemented system as in FIG. 9.

### DETAILED DESCRIPTION

The present systems and methods provides approaches comprising magnitude enhancement analysis and configured to display intensity-related features of high-bit images, such as grayscale, on low-bit display systems, without distorting the underlying intensity unless desired, measuring the thickness of materials, and/or enhancing perception of saturation, hue, color channels and other color space dimensions in a digital image, and external datasets related to a 2d image. These various aspects and embodiments provide improve systems and approaches to display and analyze, particularly through the human eye (HVS).

Turning to a general discussion of human observational characteristics generally related to high bit display on low bit display terminals, the capture and processing of grayscale in an image can be considered as 2 portions: First, the display portion includes the image acquisition, film/data processing and the display of grayscale image intensities. The display may be a variety of methods including CRT monitor, transparency film on a light box, printed hardcopy photographs, and more. The display process is designed to portray an image judged by the observer to correctly represent the source scene. Second, the observation portion includes human observer perception of the grayscale image intensity display, subject to a wide variety of individualized perception limitations (e.g., age) and environmental surrounding factors (e.g., ambient lighting level). While HVS is highly adaptable to changes in luminous intensity, HVS is relatively poor at quantitatively identifying similar intensities separated by distances or by a few seconds of time. HVS has poor ability to determine exact intensity values.

The conflict between limited grayscale display capabilities and the need for accurate reproduction of wide ranging grayscale scene image information can be treated with the innovative approaches herein. The 3D surface construction relieves the image display equipment from the requirement of accurate grayscale tonal intensity reproduction, or the use of image processing to compress high dynamic range (HDR) intensities for display on low dynamic range (LDR) devices. See, e.g., Digital Imaging and Communications in Medicine (DICOM) Part 14: Grayscale Standard Display Function, http://medical.nema.org/; CRT/LCD monitor calibration procedure, http://www.brighamandwomens.org/radiology/Research/vispercep.asp; Display of high dynamic range data on a low dynamic range display devices, J. DiCarlo and B. Wandell, Rendering High Dynamic Range Images, In Proceedings of the SPIE Electronic Imaging '2000 conference, Vol. 3965, p.p. 392-401, San Jose, Calif., January 2000).

Portraying grayscale intensity as Z-axis elevations produces a 3D surface, independent of the need for accurate grayscale tonality, hence dynamic range presentation. Scene dynamic range can be portrayed and perceived in 3-d as shapes and dimensions, with spatial units of measure providing accurate reporting of image grayscale values.

The number of grayscale shades mapped on the 3D surface matches the data contained in the electronic image file (for example, 16 bit data allows 65,536 grayscales) yet can be accurately represented on a display having lesser, e.g., 8-bit, display capabilities and/or less than 65,536 available pixels on the screen (or other display device) to show each of the shades. The methods and software, etc., herein address the challenging task of accurate display and perception of, e.g., JNDs or widely varying extremes of dynamic range in grayscale values. Examples of extreme ranges include sunlight, bright lamp intensities, cave-like darkness, which can be mapped to the 3D surface representations herein and presented for observation. The quality of image acquisition can be the limiting factor controlling the number of potential grayshades available for display and perception. The systems, etc., herein comprise providing and using an interactive surface elevation (3d) representation that allows extremely small, as well as very large, changes in grayscale values to be mapped with high accuracy and detail definition.

The systems, etc., transform grayscale image intensity/film density to a 3D surface representation of the grayscale image intensity/film density, where grayscale tonal values are transformed into “elevation” shapes and forms corresponding to the grayscale value of the respective pixel. The elevation shapes and forms can be represented at any chosen contrast levels or hues, avoiding grayscale tonal display and HVS perception issues. The systems, etc., provide methods of displaying grayscale shades of more than 8 bits (more than 256 shades) and higher (16 bit, 65,536 grayscale for example) on conventional display equipment, typically capable of a maximum of 8 bit grayscale discrimination. This is done by mapping the digitized grayscale image spatial information on the X and Y axes of the image while plotting the grayscale value on a Z-axis or elevation dimension.

The resulting three dimensional surface can assign any desired length and scale factor to the Z-axis, thus providing display of grayscale information equal to or exceeding the common 256 grayscale limitation of printers, displays, and human visual perception systems. By these approaches, a full range of grayscale extremes and subtle changes can be perceived at one or more moments by the human visual perception system.

In this and other embodiments (unless expressly stated otherwise or clear from the context, all embodiments, aspects, features, etc., can be mixed and matched, combined and permuted in any desired manner), a variety of interactive tools and aids to quantitative perception can be used, such as zoom, tilt, pan, rotation, applied color values, isopleths, linear scales, spatial calibration, mouse gesture measurement of image features, surface/wireframe/contour/grid point mapping, contour interval controls, elevation proportions and scaling, pseudocolor/grayscale mapping, color/transparency mapping, surface orientation, surface projection perspectives, close-up and distant views, comparison window tiling and synchronization, image registration, image cloning, color map contrast control by histogram equalize and linear range mapping. Additional tools can be also be used.

The Z-axis of a high bit level surface image can be assigned a scale factor consistent with the bit level of the image, such as 1024 for 10 bit image, 4096 for 12 bit image and so-on. In this way, the monitor or printer no longer needs to provide the 1024 or 4096 gray shades reproduction and discrimination ability, since the Z-axis dimension represents the gray shade as a unit of distance along the Z-axis. The image can be viewed using interactive tools discussed elsewhere herein, for example, zooming and rotating for improved viewing perspectives.

Often, data is not compressed due to a desire to view the unaltered high dynamic range data. An alternative processing scheme, such as “windows” and “leveling” is provided. In this case, the grayscale values exceeding the monitor's or printer's capability requires the analyst to adjust the output of the display using image processing tools. Typically, a new portion of the overall grayscale will become visible at the expense of losing visibility of another portion of the grayscale.

The adjustment process uses the term “window” to discuss a subset of the overall grayscale range, 256 of 4096 for example. This “window” may be located to view grayscale values at midtone “level” (1920 to 2176), extremely dark “level” (0 to 255), or elsewhere along the 4096, 12 bit scale. For an extremely dark example, a 256 grayscale portion (window) of extremely dark (level) grayscales from the 4096 or other high bit level image, would be adjusted to display those dark grayscales using midtone level grayscales readily visible to the HVS on common display equipment, otherwise the balance of 3840+ grayscales (4096 minus 256) in the 12 bit image would generally not be visible on the display to the human eye, and possibly not distinguished by the display itself. By use of a 3 dimensional surface, the extremely dark shades are visible without adjustment (window and level), as well as the midtone and extremely light shades of gray. All 4096 grayscale values will be available for HVS perception (or more, if desired) as 3D surface object.

Printing devices have limited grayscale reproduction capability as well. Printing devices benefit from this innovations in the same manner as electronic display devices.

Mapping the grayscale value to elevation has the additional benefit of disrupting some grayscale illusions. (See Grayscale visual perception illusions by Perceptual Science Group at MIT; http://web.mit.edu/persci/.) Grayscale illusions are the result of human visual perception systems performing adjustments to an image to match our a priori knowledge of the image (e.g., checkerboard illusion), enhancing edges for improved detection (e.g., mach bands), and other low and high order vision processes.

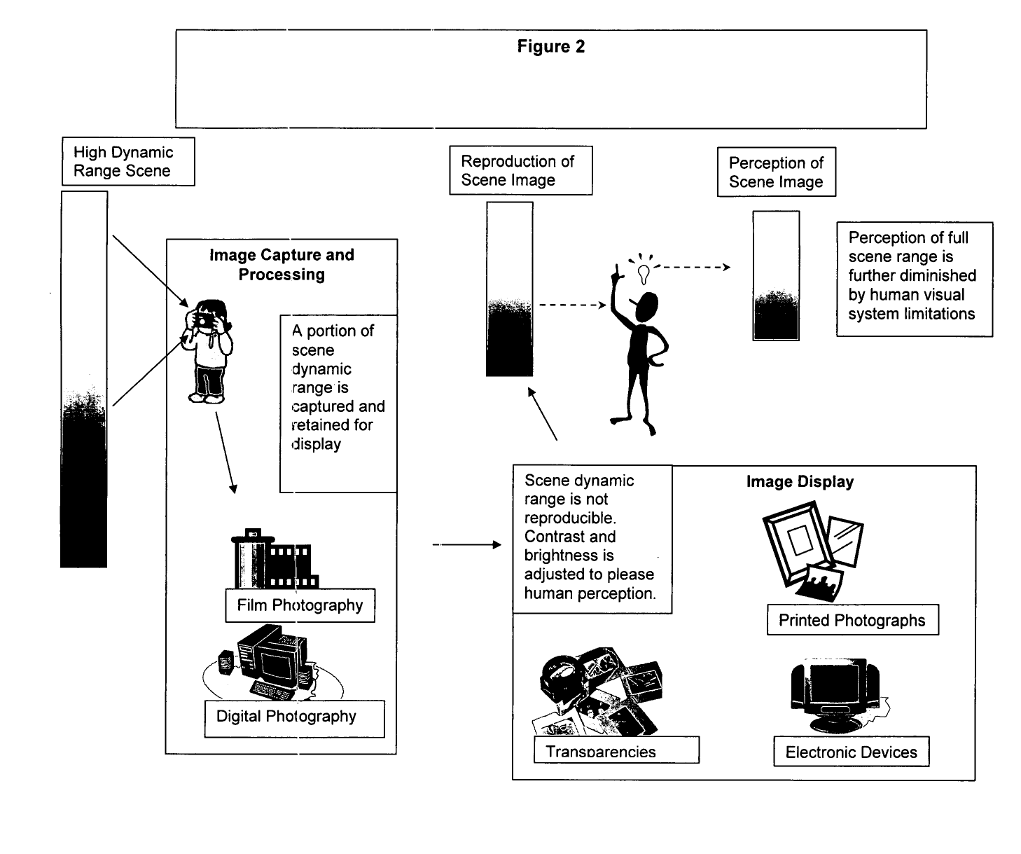

The following provides an example, including supporting discussion, of high bit display on low bit display systems. Presentation of a scene image for human perception involves a process of transformations that can be as illustrated in FIG. 2. The following five steps are useful to discuss the process:
1. Scene—The range of luminous intensities which exist in a scene can be extremely large, exceeding the intensity variations perceived by human visual adaptation. HVS adaptation given sufficient time can exceed 100 million to 1 ratio (10⁹, starlight to bright daylight). The range of scene intensities can also be very low, such as a monotone painted wall, with very subtle intensity variations.
2. Capture Device—Typical photographic intensity ratio capture is less than 10,000 to 1 (10⁴) maximum. Capture limitations are technical/hardware related, such that high quality, medical/scientific/military devices capture a greater dynamic range and store the information as high bit level data. High bit level data is common with high quality devices, while consumer/office quality digital capture devices default to 8 bit grayscale resolution. This requires compression or other alteration of the high bit level data, reducing grayscale resolution to 256 grayscale tones. Film photography typically captures higher dynamic range and higher grayscale resolution than consumer/office quality devices, although digital methods are advancing quickly.
3. Image Processing—Special purpose, scientific/military image processing methods can retain the full captured dynamic range as well as using high bit level data to provide high resolution of grayscale values. Film methods typically capture higher dynamic range and higher grayscale resolution than consumer/office digital methods. But, digital methods are improving rapidly and are trending to displace film methods. Consumer/office quality digital image processing defaults to 8 bit methods, with resultant loss of grayscale value resolution.
4. Image Display—Reproduction of the image by CRT monitor or printed paper photograph produces a luminance dynamic range of approximately 100:1 (ref 9, 10). While human perception can adapt within a few seconds to perceive luminance values over a wider range, such wider range luminance information cannot be accurately reproduced by consumer/office quality display devices. Technology advances including LCD/LED/plasma displays provide some dynamic range improvements, and the improvement trend is expected to continue.
5. Observer—human vision can operate over a wide range of dynamic range intensities (10⁹) given sufficient adaptation time. A narrower range (10⁴) is comfortably adapted over a short time, and an even narrower range is perceived without adaptation, approx 100:1. This narrow range is very similar to the image display hardware maximum range. The close match of display quality and HVS instantaneous grayscale perception can be a result of R&D defining HVS skills.

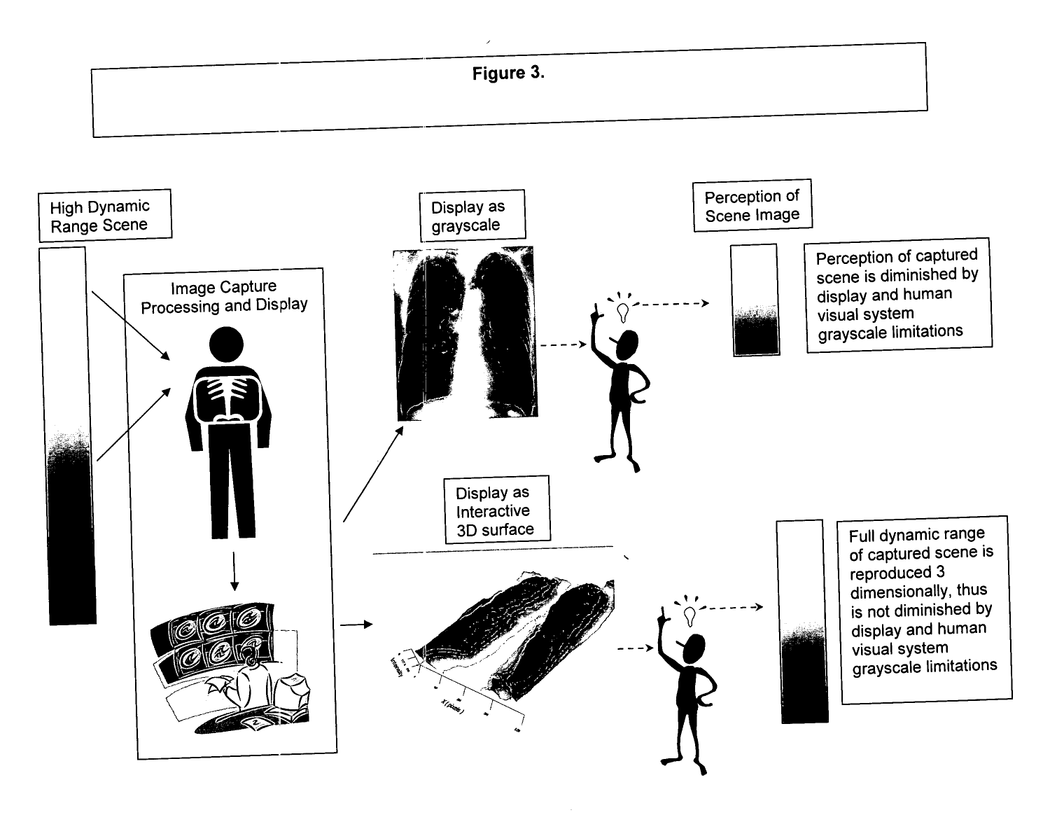

The processes, etc., herein can be employed, for example, at the image processing steps, image display and HVS observation steps 3, 4, and 5 in FIG. 2. The processes, etc., transform the image from a grayscale tonal or luminance reproduction to a 3D surface as shown by the lower “path” in FIG. 3. The 3D surface representation as compared to conventional 2D methods is illustrated in FIG. 3 for the example of a chest X-ray image. The full dynamic range obtained at the image capture stage can be retained and displayed to the observer free of the image processing, display and perception constraints of the conventional grayscale intensity representation method (upper “path” of FIG. 3). Application of the 3D surface method can utilize image data as it exists prior to conventional image processing methods of brightness and contrast adjustment or dynamic range compression.

As noted above, the processes transform the 2D grayscale tonal image to 3D by “elevating” (or depressing, or otherwise “moving”) each desired pixel of the image to a level proportional to the grayscale tonal value of that pixel in its' 2D form. The pixel elevations can be correlated 1:1 corresponding to the grayscale variation, or the elevations can be modified to correlate 10:1, 5:1, 2:1, 1:2, 1:5, 1:10, 1:20 or otherwise as desired. (As noted elsewhere herein, the methods can also be applied to image features other than grayscale, such as hue and saturation; the methods, etc., herein are discussed regarding grayscale for convenience.) The ratios can also be varying such that given levels of darkness or lightness have one ratio while others have other ratios, or can otherwise be varied as desired to enhance the interpretation of the images in question. Where the ratio is known, measurement of grayscale intensity values on a spatial scale (linear, logarithmic, etc.) becomes readily practical using conventional spatial measurement methods, such as distance scales or rulers.

The pixel elevations are typically connected by a surface composed of an array of small triangular shapes (or other desired geometrical or other shapes) interconnecting the pixel elevation values. The edges of each triangle abut the edges of adjacent triangles, the whole of which takes on the appearance of a surface with elevation variations. In this manner, as shown in FIG. 2, the grayscale intensity of the original image resembles a topographic map of terrain, where higher (mountainous) elevations could represent high image intensity, or density values. Similarly, the lower elevations (canyon-lands) could represent the low image intensity or density values. The use of a Z-axis dimension allows that Z-axis dimension to be scaled to the number of grayscale shades inherently present in the image data. This method allows an unlimited number of scale divisions to be applied to the Z-axis of the 3D surface, exceeding the typical 256 divisions (gray shades) present in most conventional images. High bit level, high grayscale resolution, high dynamic range image intensity values can be mapped onto the 3D surface using scales with 8 bit (256 shades), 9 bit (512 shades), 10 bit (1,024 shades) and higher (e.g., 16 bit, 65,536 shades).

As a surface map, the image representation can utilize aids to discrimination of elevation values, such as isopleths (topographic contour lines), pseudo-colors assigned to elevation values, increasing/decreasing elevation proportionality to horizontal dimensions (stretching), fill and drain effects (visible/invisible) to explore topographic forms, and more.

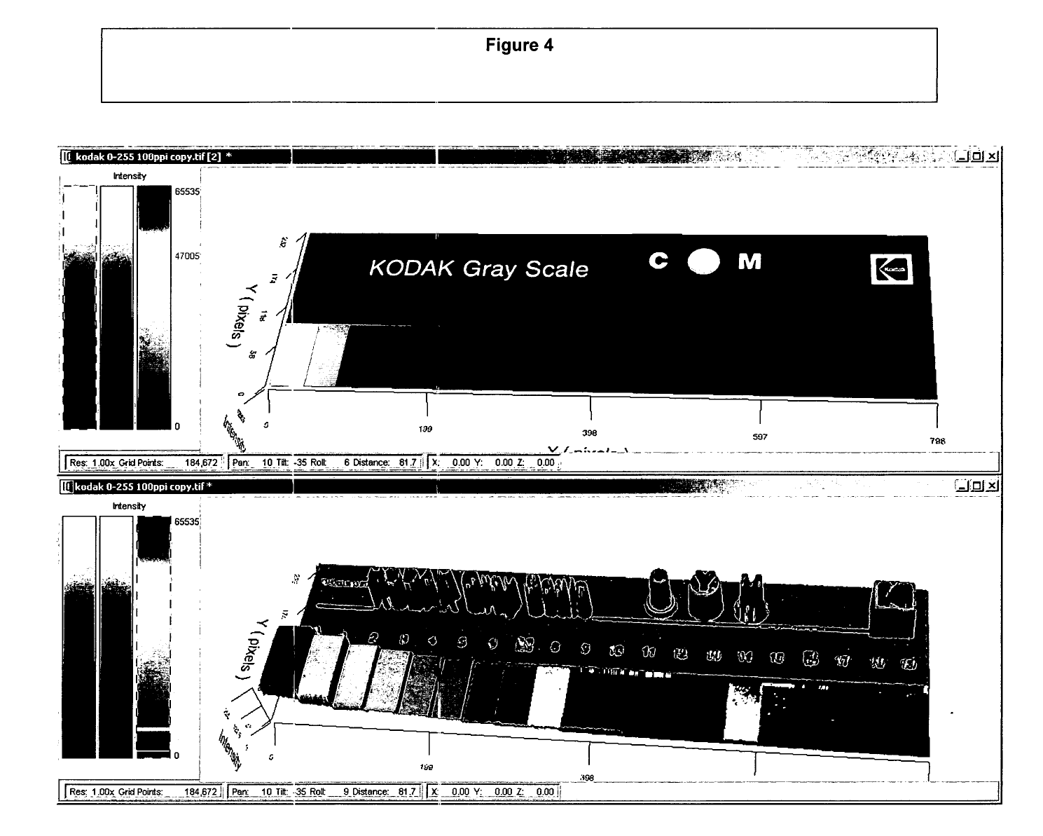

FIG. 4 illustrates a 3D surface method of mapping image intensity using a standard reference object. The exemplary object is the Kodak grayscale Q-13, Catalog number 152 7654, a paper-based grayscale target for quality control of photographic images. The dynamic range of grayscale is from 0.05 density to 1.95 in 20 density steps of 0.10 density increments. This scale closely matches photographic grayscale reproduction range capability. The observer will note the darkest grayscale targets will appear to be very similar to one another. The dark shades appear very similar, despite the fact that density increments vary by the constant value of 0.10 units between them. Using the systems herein, the elevation dimension can be used to discriminate between these very similar shades, as well as use of pseudo-color mapping as shown in FIG. 4.

The Kodak target is a low dynamic range object, representative of grayscale range reproducible with photographic methods. High dynamic range images with many times darker and brighter regions can also be accurately reproduced using the systems, etc., herein. As an elevation map, these dark and bright shades can be readily observable as shapes corresponding to that grayscale value.

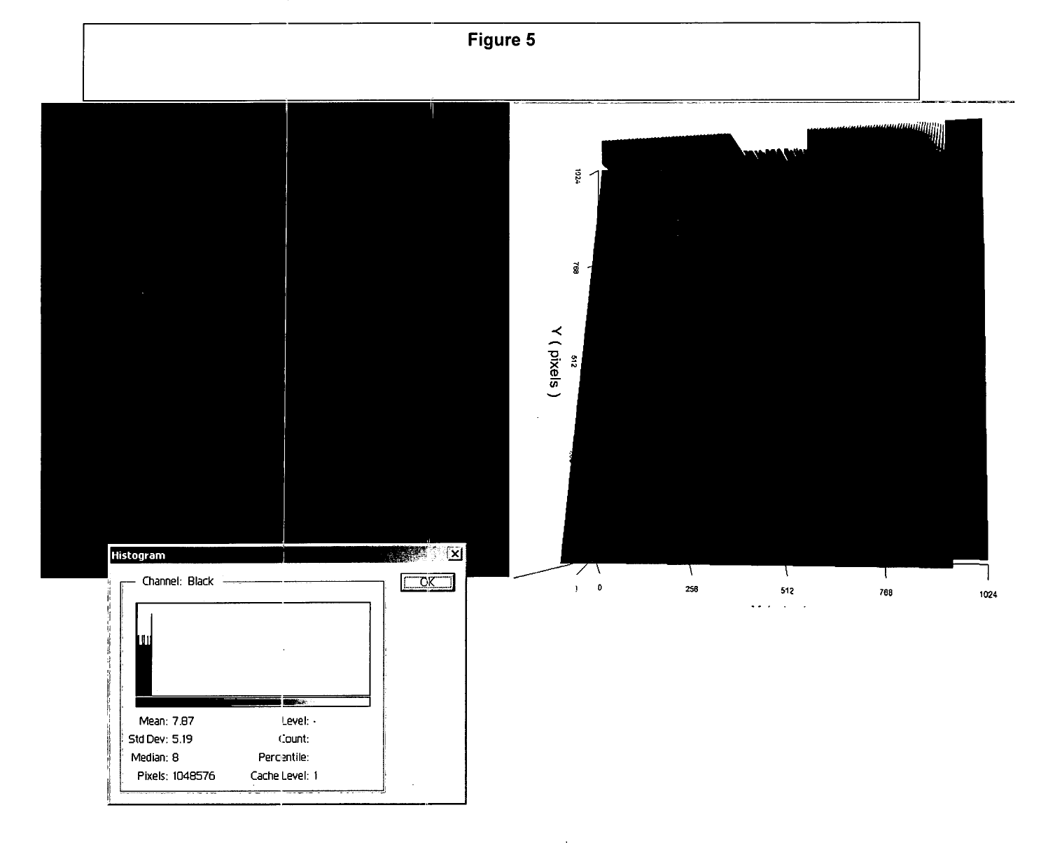

High bit level images shown as a 3D surface can accurately portray grayscale intensity information that greatly exceeds display device ability to accurately reproduce HDR grayscale intensity tonal values. Transformation of extreme (and subtle) gray shades to a 3 dimensional surface as discussed herein provides spatial objects for detection by HVS, and for display devices. FIG. 5 is a side-by-side comparison of a test pattern image available from the American Association of Physicists in Medicine, Task Group 18 (AAPM TG18: American Association of Physicists in Medicine Task Group 18 http://deckard.mc.duke.edu/˜samei/tg18). The 16 bit image (TG18-PQC Test Pattern for Comparison of Printed Film and Electronic Display Luminance) is shown on the left side as it would normally appear on a conventional electronic display. On the right hand side is the image as it appears using the methods herein, a 3D surface elevation object rotated to show the resulting surface shape.

The image data in the very low intensity range 0-4,096 of 65,536 of full range grayscale, typical of radiography procedures. The contrast sensitivity of radiographic films is optimized in this low intensity range. Image intensity data is not altered in either view of FIG. 5, the 3D surface is much more visible as compared to the adjacent normal 2D tonal intensity view, plus interactive software tools can be used for further evaluation.

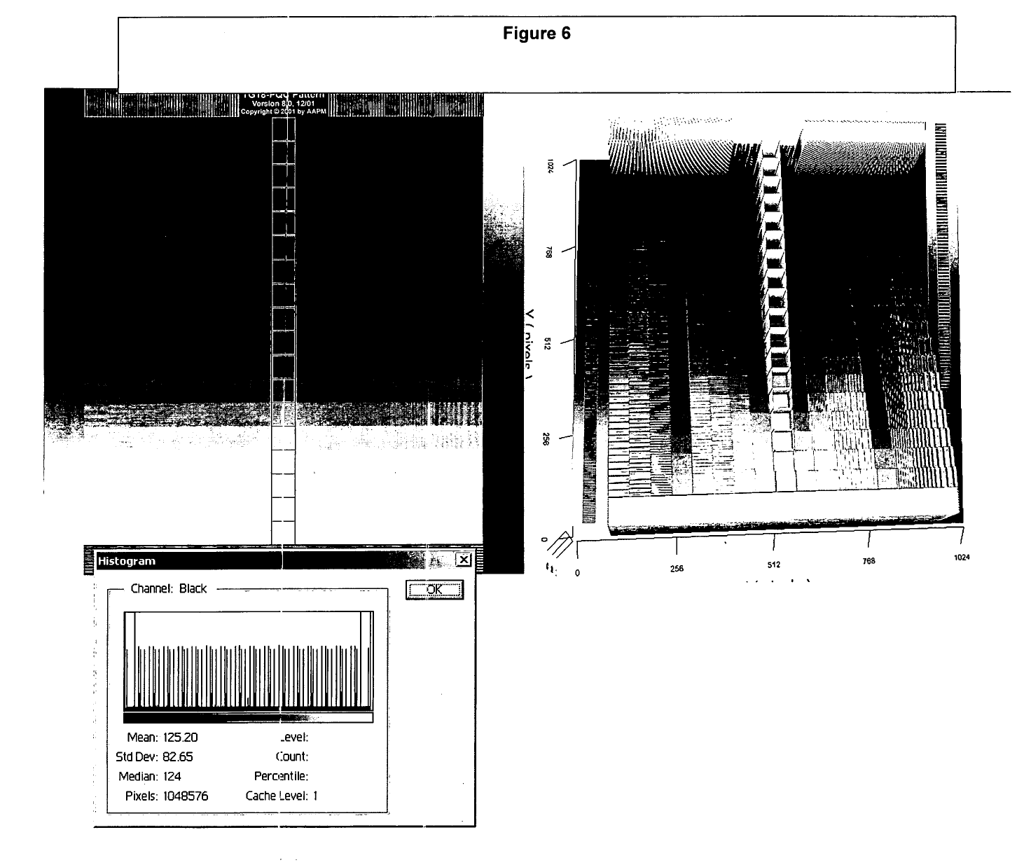

FIG. 6 illustrates a common treatment of image data for 2D viewing, adjusting the brightness or level of the data to bring the grayscale values into a region where display devices can reproduce, and HVS can perceive, the (altered) tonal values. Comparing the histogram of FIG. 6 to histogram of FIG. 5 identifies the alterations to the image data.

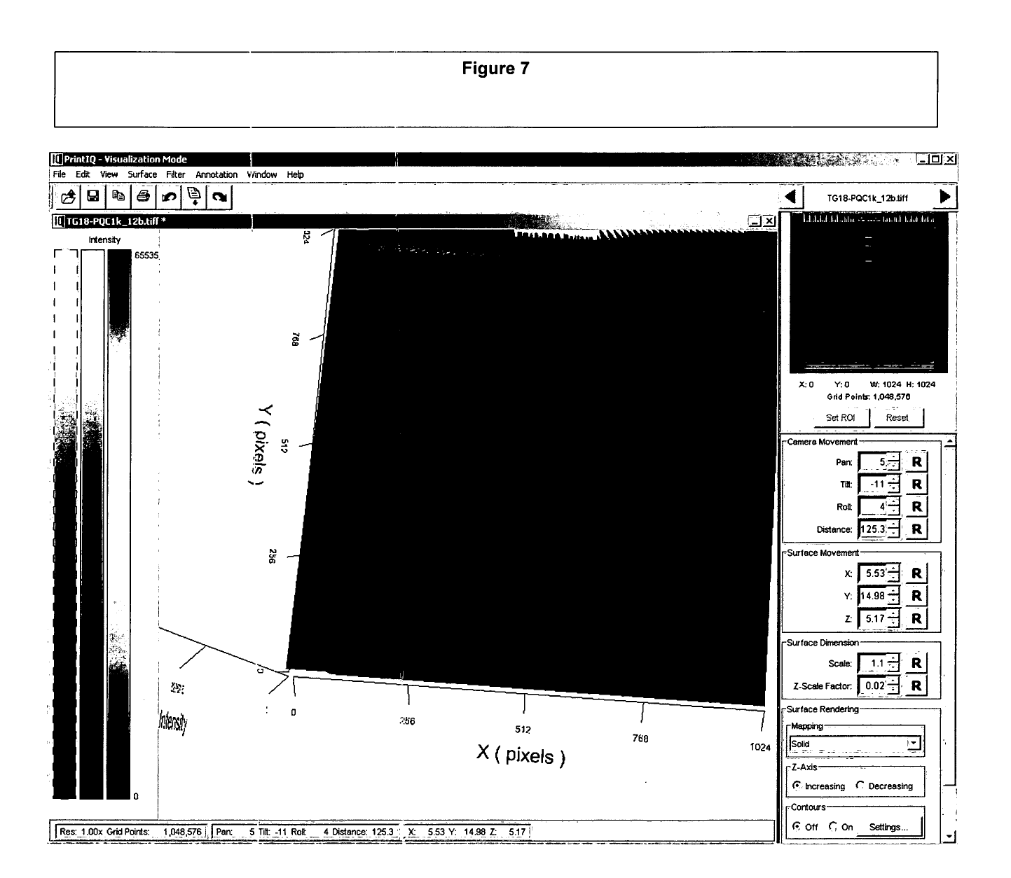

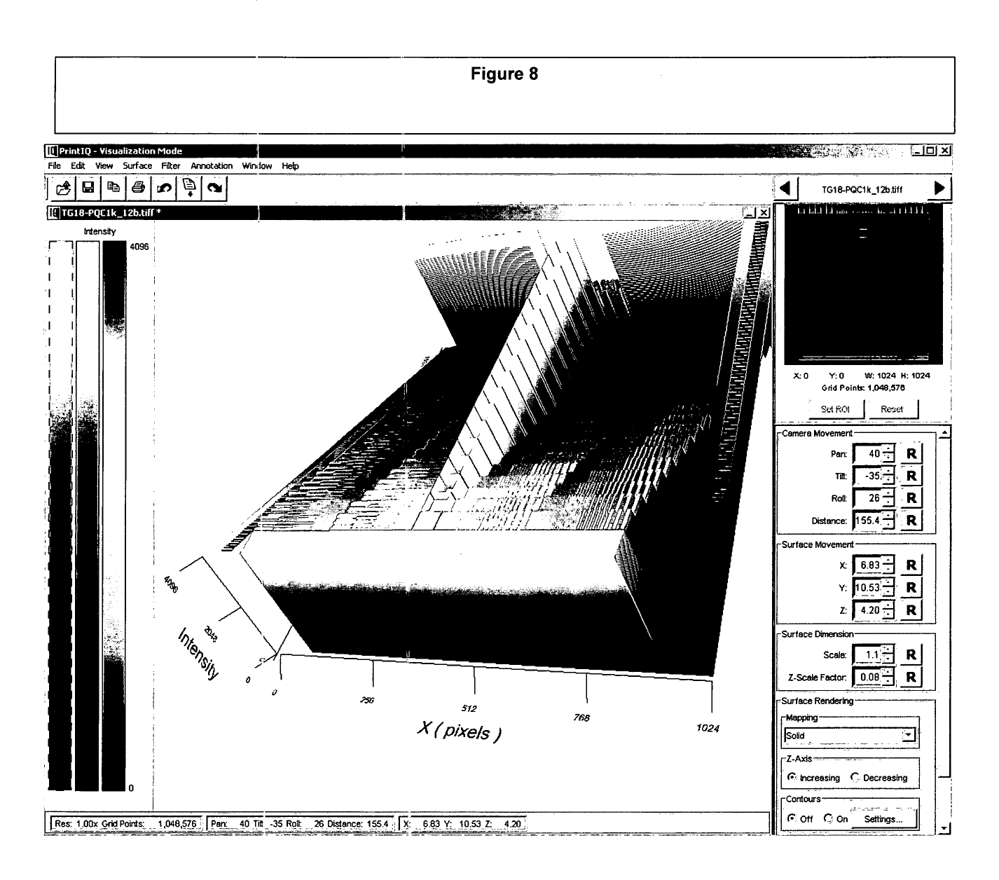

FIG. 7 illustrates the same image as FIG. 5, with no contrast adjustments, full grayscale range of 0 to 65,536. The Z-axis projects out of the field of view in this case, since the image is a test pattern for radiographic displays. The software interface is shown to illustrate certain tools available for further image data evaluation actions. FIG. 8 is the same image data with the Z-axis “clipped” via a viewing window to the grayscale region of interest (0 to 4096), boosting 3d surface visibility without alteration to the image dataset.

Turning to a general discussion of methods, apparatus, etc., for determining the thickness of a material using magnitude enhancement analysis, the systems and software herein can indicate corrosion, defects or other artifacts in a an imaged, e.g., radiographed, object. Review of industrial images shows that the software, by accurately measuring and projecting/displaying minute variations in radiographic image grayscale values, can provide NDE analysts with tools to accurately measure the thickness of the underlying image.

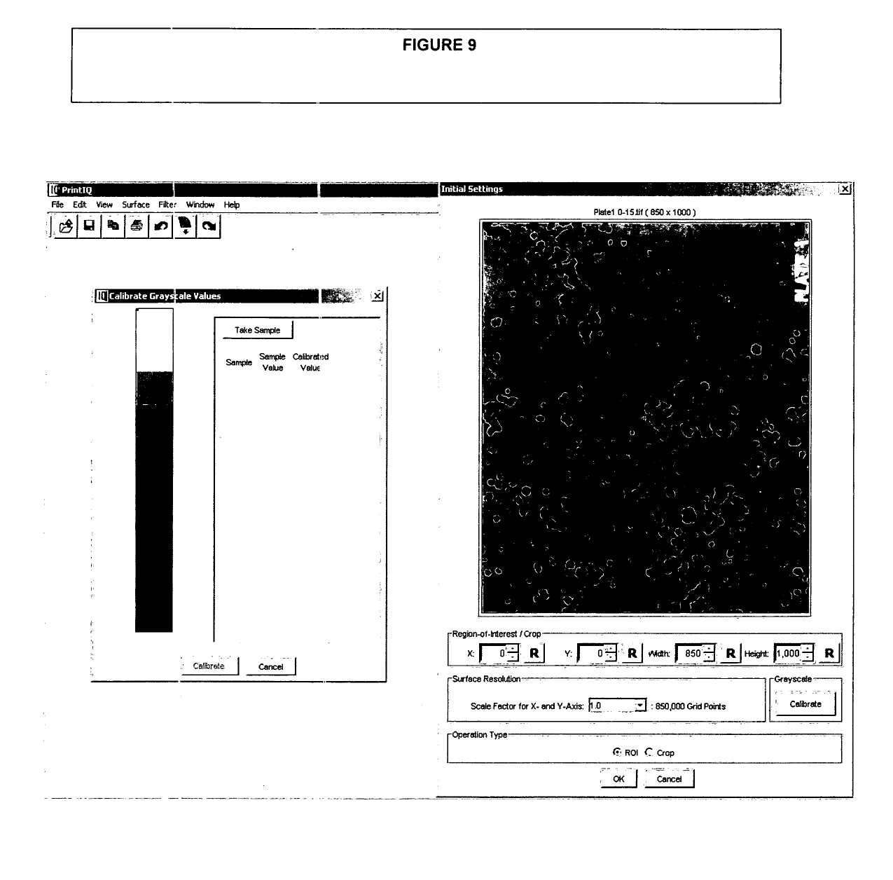

Exemplary methodology as applied to industrial images can be as follows:
1. The thickness of material in the radiographic image directly modulates or attenuates radiation (or other transmissive scanning mechanism) passing through the material. Radiation reaching the film or digital sensor interacts with the film or sensor to provide a grayscale tonal image corresponding to the radiation exposure level. The grayscale tonal value can be calibrated by use of a thickness reference block, so that an accurately dimensioned Z-axis, or thickness dimension, is presented in the 3D surface image. Certain mathematical correction factors can be built into the imaging software to correct for possible distortions caused by radiation physics. Once the radiograph is in digital format (either through scanning of physical film, or through direct digital capture, or otherwise as desired), the software herein measures the grayscale variations and projects them as a 3D surface. In rendering the surface, the software can incorporate algorithms to correct for any distortions created by radiation physics. Surface elevation variations in the image will correspond to actual thickness of the material in the radiograph image.
2. Calibration of the image intensity/surface elevation to material thickness via the radiographic image can be accomplished by including reference objects of known thicknesses or other standards in the radiographic image field of view. Commonly, Image Quality Indicators (IQIs) are specified by ASTM (American Society of Testing and Materials) and ASME (American Society of Mechanical Engineers) to verify industrial radiographic image quality sharpness and contrast sensitivity. Similarly, step wedge thickness blocks can be included for reference to grayscale intensity versus thickness. These same reference items can be used with the systems and software herein to calibrate the grayscale intensity to the Z-axis (thickness) scale, labeling the scale with units and increments of thickness.
3. As part of the implementation, known step wedge thickness values or other comparison standards can be depicted in the software corresponding to the grayscale value of that target region of the image. Multiple step wedge thickness regions, covering the thickness range of the material in the image, can be entered as calibration values into the software. In this manner, grayscale values depicted as a 3D surface in the software and actual thickness values can be co-related to one another (calibrated). The software can dimension the grayscale intensity axis (Z-axis) with incremental values of thickness (inches, millimeters, and similar).
4. The radiographic grayscale intensity image can be represented as a 3D surface, where peaks and valleys of Z-axis “elevation” will correspond to shadows and highlights (or vice versa), for example. In radiographic images, highlights are areas of greatest radiation attenuation (thickest material) and shadows are areas of least attenuation (thinnest, or no material). The software can display the thinnest locations as valleys and the thickest materials as high elevations or peaks (or vice versa). In this way, the 3D surface image becomes an intuitive representation of material thickness in the radiograph. Elevation or thickness demarcations (contour lines) can be readily applied. A variety of other software tools are available to aid in exact mapping or measurement of the thickness represented in the image.
5. This aspect is also applicable to detection and measurement of corrosion in materials, detection of thickness and degradation of layered materials (thickness of paint on painted metallic surface), and similar inspection areas. By allowing expert examiners to visualize defects more clearly and intuitively, it can also assist in pattern recognition and automated defect detection. In effect, if the people who write pattern recognition algorithms can see defect patterns more clearly through 3D depiction of grayscale patterns and thickness, they can then write more precise algorithms—which can improve defect recognition.
6. The illustrations and text attached hereto as FIG. 9 demonstrate an implementation of this method using the software.

Uses of such a tool can include measurement of storage tank wall thickness, piping wall thickness, castings quality, as well as any other conventionally radiographed object or material. If desired, an object of known thickness (e.g., step wedge) or other standard can be included in the field of view to provide a thickness versus grayscale calibration reference, but in other respects, normal radiographic procedures can be applied if desired. In this manner, large areas of the radiographic image can accurately portray the object thickness. Correction factors taking into account the geometric arrangement of point source radiation, object being radiographed, and the radiation sensor/detector producing the image can be included in the calibration, software or otherwise, of image intensity to material thickness.

In one embodiment, these methods, systems, etc., provide for area-wide measurement of the thickness of homogenous material (or other suitable material) using conventional radiographic image acquisition. In one embodiment of carrying this out, ASTM and ASME radiographic requirements include the use of IQI as well as step wedge reference objects. Use of step wedge object(s) in the radiographic image field of view provides a suitable reference object, if needed, for grayscale versus thickness calibration using the software interface. Along with geometric correction factors, the reference object is used to calibrate, or quantify thickness in the entire field of view.

By exemplary comparison, conventional practice requires manual use of a densitometer instrument as the step wedge and an individual location in the image to provide a thickness measurement at that point. Each additional point of thickness measurement requires repetition of the measurement process. The end result is a tabulation of measurements data, as compared to a 3D surface image representation of object thickness. Further, the image rendered in the software of the present innovations is quantitatively accurate for thickness, and the software interactivity provides statistical, area-wide, as well as point specific thickness information.

In another embodiment, the systems, etc., provide improved effectiveness of thickness evaluations based upon radiographic methods of scanning a substrate then viewing it or analyzing it using the methods herein. The thickness measurement methods may be applied to digitized film images as well as digital radiographic methods. The method provides a common mode means of thickness determination regardless of radiographic method or image type.

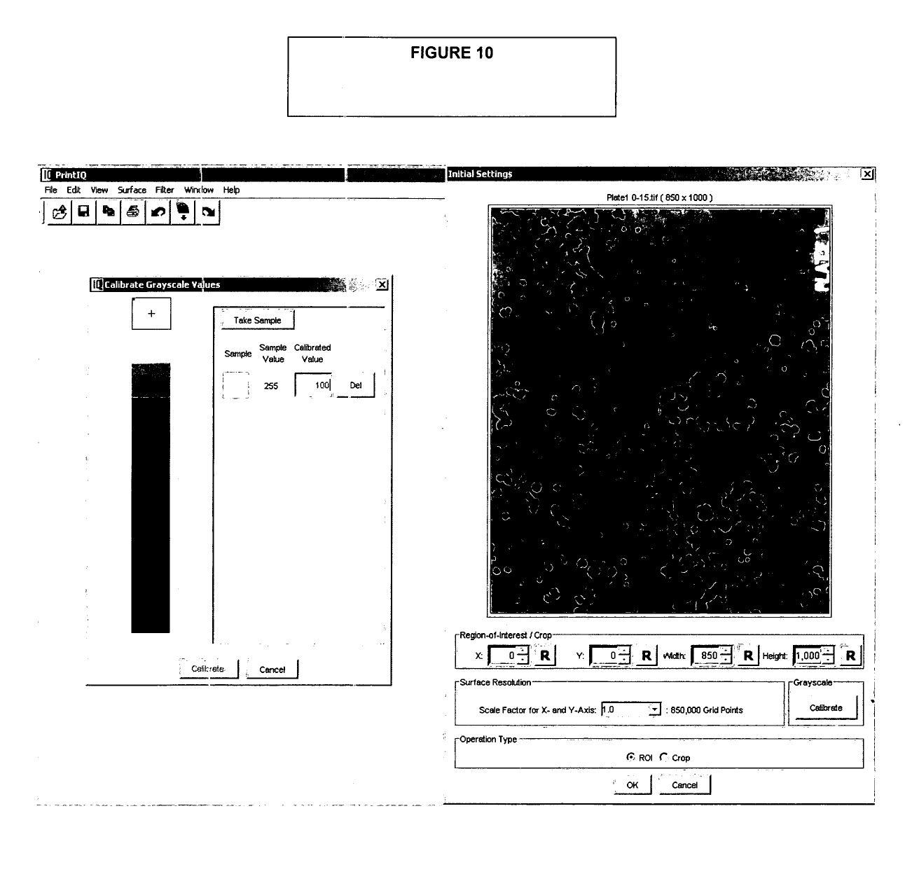

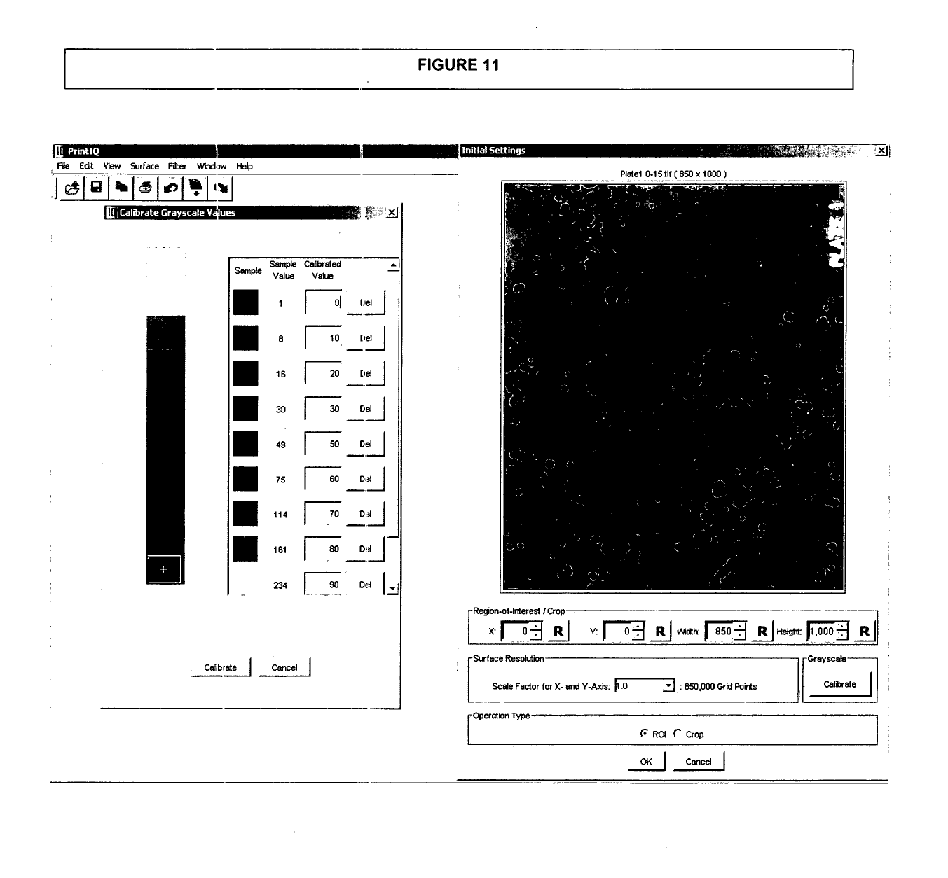

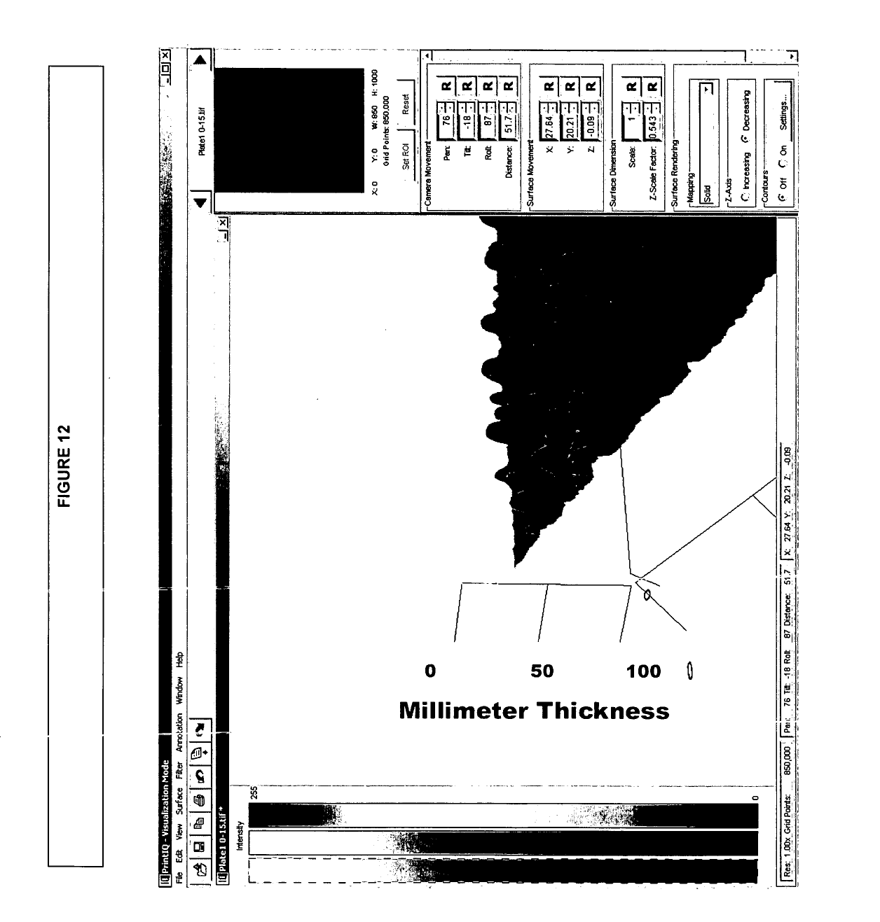

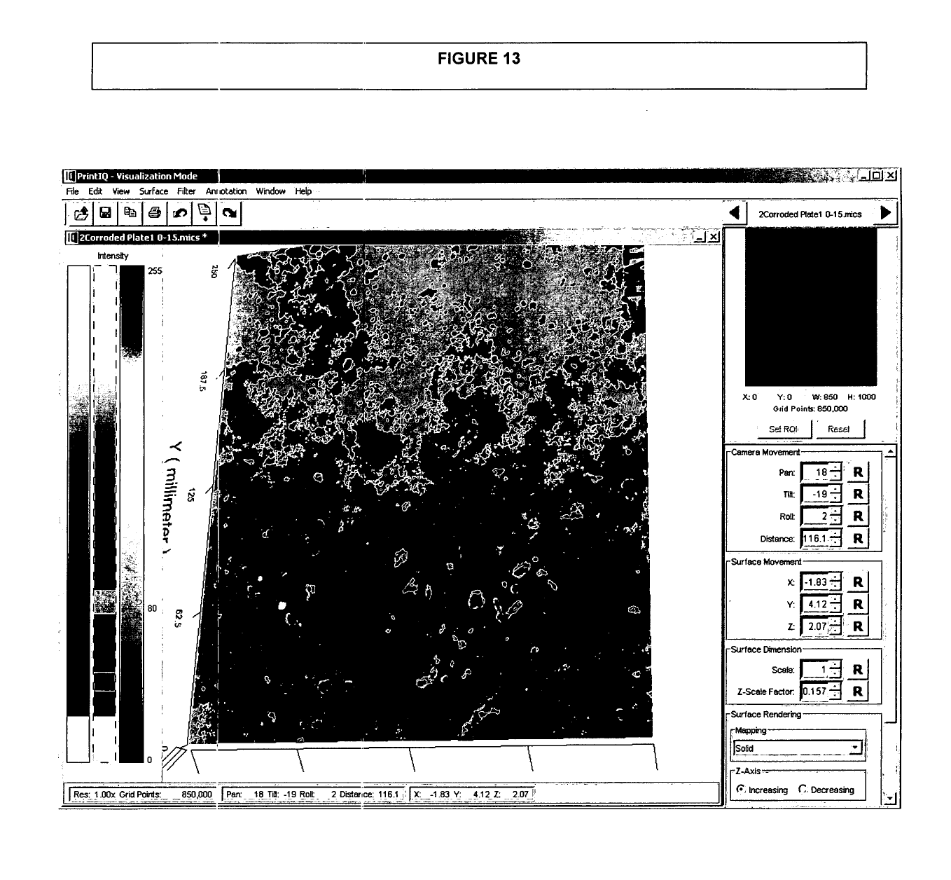

The following paragraphs discuss an exemplary thickness measurement work flow process.
1. As shown in FIG. 9 perform a radiographic imaging procedure, typically per accepted industry code requirements. The image can have a suitable thickness reference object in the field of view (e.g., a step wedge).
2. The reference object properties can:
   a. be identical material to object of interest,
   b. have thickness values to provide intermediate thickness values with respect to the object of interest,
   c. be located adjacent to object of interest.
3. Typically, if the image is a film radiograph, convert the film by electronic image scanning or other desired procedure to provide a digital file. If the image is a direct digital radiograph, no additional conversion may be desired.
4. Import, or “open” the digital file using magnitude enhancement analysis software. Perform thickness calibration to grayscale values using the exemplary interactive grayscale calibration tool in software in FIGS. 9 and 10.
5. As shown in FIG. 10 each subsection of the grayscale target has a known thickness value by design and construction of the target (step wedge). Using the mouse to select each subsection (one at a time) and then clicking “Take Sample” produces the following result. The numbered numerical value under “calibrated value” is the actual material thickness value entered by the operator for the sampled portion of the grayscale target (step wedge). This and certain other steps can be automated, if desired.
6. As shown in FIG. 11, repetition of this procedure can sample additional regions of the grayscale target until completely sampled. The “Calibrate” button is clicked, resulting in adjustment of the Z-axis to reflect the thickness values entered numerically. As with the previous steps, this and certain other steps can be automated, if desired.
7. As shown in FIG. 12, once tonal values and thickness values are calibrated, and corrected for radiation physics effect due to factors such as point source radiation targeting a flat plate, the image can be viewed as a quantitative representation of material thickness, as shown below. This demonstration example uses millimeter as the thickness unit of measure.
8. As shown in FIG. 13, existing additional software tools can be used for evaluation of material thickness throughout the image region. The example below demonstrates the use of pseudo-color tools. The thinnest regions of the plate have been made invisible, allowing the white background “shows-through” the plate. Deeper blue tones correspond to equal thickness values, and lighter blue tones correspond to another set of equal thickness values.

Turning to another aspect, digital images have an associated color space that defines how the encoded values for each pixel are to be visually interpreted. Common color spaces are RGB, which stands for the standard red, green and blue channels for some color images and HSI, which stands for hue, saturation, intensity for other color images. There are also many other color spaces (e.g., YUV, YCbCr, Yxy, LAB, etc.) that can be represented in a color image. Color spaces can be converted from one to another; if digital image pixels are encoded in RGB, there are standard lossless algorithms to convert the encoding format from RGB to HSI.

The values of pixels measured along a single dimension or selected dimensions of the image color space to generate a surface map that correlates pixel value to surface height can be applied to color space dimensions beyond image intensity. For example, the methods and systems herein, including software, can measure the red dimension (or channel) in an RGB color space, on a pixel-by-pixel basis, and generate a surface map that projects the relative values of the pixels. In another example, the present innovation can measure image hue at each pixel point, and project the values as a surface height.

The pixel-by-pixel surface projections can be connected through image processing techniques (such as the ones discussed above for grayscale visualization technology) to create a continuous surface map. The image processing techniques used to connect the projections and create a surface include mapping 2D pixels to grid points on a 3D mesh (e.g., triangular or rectilinear), setting the z axis value of the grid point to the appropriate value (elevating based on the selected metric, e.g., intensity, red channel, etc.), filling the mesh with standard 3D shading techniques (gouraud, flat, etc) and then lighting the 3D scene with ambient and directional lighting. These techniques can be implemented for such embodiments using modifications in Lumen's grayscale visualization software, as discussed in certain of the patents, publications and applications cited above.

Virtually any dimension, or weighted combination of dimensions in a 2D digital image, can be represented as a 3D surface map. Other examples include conversion of the default color space for an image into the HLS (hue, lightness, saturation) color space and then selecting the saturation or hue, or lightness dimensions as the source of surface height. Converting to an RGB color space allows selection of color channels (red channel, green channel, blue channel, etc.). The selection can also be of single wavelengths or wavelengths bands, or of a plurality of wavelengths or wavelength bands, which wavelengths may or may not be adjacent to each other. For example, selecting and/or deselecting certain wavelength bands can permit detection of fluorescence in an image, detect the relative oxygen content of hemoglobin in an image, or breast density in mammography.

In addition, the height of each pixel on the surface can be calculated from a combination of color space dimensions (channels) with some weighting factor (e.g., 0.5*red+0.25*green+0.25*blue), or even combinations of dimensions from different color spaces simultaneously (e.g., the multiplication of the pixel's intensity (from the HSI color space) with its luminance (from the YUV color space)).

The present innovations can display 3D topographic maps or other 3D displays of color space dimensions in images that are 1 bit or higher. For example, variations in hue in a 12 bit image can be represented as a 3D surface with 4,096 variations in surface height.

In another embodiment, the methods, systems, etc., are directed to enhanced perception of related datasets. Outside of color space dimensions, the height of a gridpoint on the z axis can be calculated using any function of the 2D data set. A function to change information from the 2D data set to a z height may take the form f(x, y, pixel value)=z. All of the color space dimensions can be of this form, but there can be other values as well. For example, a function can be created in software that maps z height based on (i) a lookup table to a Hounsfield unit (f(pixelValue)=Hounsfield value), (ii) just on the 2D coordinates (e.g., f(x,y)=2x+y), (iii) any other field variable that may be stored external to the image, or (iv) area operators in a 2D image, such as Gaussian blur values, or Sobel edge detector values.

The external function or dataset is related in some meaningful way to the image. The software, etc., can contain a function g that maps a pixel in the 2D image to some other external variable (for example, Hounsfield units) and that value can then be used as the value for the z height (with optional adjustment). The end result is a 3D topographic map of the Hounsfield units contained in the 2D image; the 3D map would be projected on the 2D image itself.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims.

1. A method of displaying a high bit level image on a low bit level display system, comprising:
a) providing an at least 2-dimensional high bit level digital image;
b) subjecting the high bit level image to magnitude enhancement analysis such that at least one relative magnitude across at least a substantial portion of the print is depicted in an additional dimension relative to the at least 2-dimensions to provide a magnitude enhanced image such that additional levels of magnitudes are substantially more cognizable to a human eye compared to the 2-dimensional image without the magnitude enhancement analysis;
c) displaying a selected portion of the enhanced image on a display comprising a low bit level display system having a bit level display capability less than the bit level of the high bit level image;
d) providing a moveable window configured to display the selected portion such that the window can move the selected portion among an overall range of the bit level information in the high bit level image.

2. The method of claim 1 wherein the selected portion comprises at least one bit level less information than the bit level of the high bit level image.

3. The method of claim 1 wherein the high bit level image is at least a 9 bit level image and the display system is no more than an 8 bit level display system.

4. The method of claim 3 wherein the high bit level image is a 16 bit level image and the display system is no more than an 8 bit level display system.

5. The method of claim 1 wherein the image is a is a digital conversion of a photographic image.

6. The method of claim 1 wherein the magnitude is grayscale.

7. The method of claim 1 wherein the magnitude comprises at least one of hue, lightness, or saturation.

8. The method of claim 1 wherein the magnitude comprises a combination of values derived from at least one of grayscale, hue, lightness, or saturation.

9. The method of claim 1 wherein the magnitude comprises an average intensity defined by an area operator centered on a pixel within the image.

10. The method of claim 1 wherein the magnitude is determined using a linear function.

11. The method of claim 1 wherein the magnitude is determined using a non-linear function.

12. The method of claim 1 wherein the magnitude enhancement analysis is a dynamic magnitude enhancement analysis.

13. The method of claim 12 wherein the dynamic analysis comprises at least one of rolling, tilting or panning the image.

14. The method of claim 13 wherein the dynamic analysis comprises at least rolling, tilting and panning the image.

15. The method of claim 13 wherein the dynamic analysis comprises incorporating the dynamic analysis into a cine loop.

16. A method of determining and visualizing a thickness of a sample, comprising:
a) providing an at least 2-dimensional transmissive digital image of the sample;
b) subjecting the image to magnitude enhancement analysis such that at least one relative magnitude across at least a substantial portion of the print is depicted in an additional dimension relative to the at least 2-dimensions to provide a magnitude enhanced image such that additional levels of magnitudes are substantially more cognizable to a human eye compared to the 2-dimensional image without the magnitude enhancement analysis;
c) comparing the magnitude enhanced image to a standard configured to indicate thickness of the sample, and therefrom determining the thickness of the sample.

17. The method of claim 16 wherein the method further comprises obtaining the at least 2-dimensional transmissive digital image of the sample.

18. The method of claim 16 wherein standard is a thickness reference block.

19. The method of claim 16 wherein the sample is substantially homogenous.

20. The method of claim 16 wherein the thickness reference block and the sample are of identical material, the thickness reference block has thickness values to provide intermediate thickness values with respect to the object of interest, and are located substantially adjacent to each other.

21. The method of claim 16 wherein the magnitude is grayscale.

22. The method of claim 16 wherein the magnitude comprises at least one of hue, lightness, or saturation.

23. The method of claim 16 wherein the magnitude comprises a combination of values derived from at least one of grayscale, hue, lightness, or saturation.

24. The method of claim 16 wherein the magnitude comprises an average intensity defined by an area operator centered on a pixel within the image.

25. The method of claim 16 wherein the magnitude is determined using a linear function.

26. The method of claim 16 wherein the magnitude is determined using a non-linear function.

27. The method of claim 16 wherein the magnitude enhancement analysis is a dynamic magnitude enhancement analysis.

28. (not entered)

29. The method of claim 28 wherein the dynamic analysis comprises at least rolling, tilting and panning the image.

30. A method of displaying a color space dimension, comprising:
a) providing an at least 2-dimensional digital image comprising a plurality of color space dimensions;
b) subjecting the 2-dimensional digital image to magnitude enhancement analysis such that a relative magnitude for at least one color space dimension but less than all color space dimensions of the image is depicted in an additional dimension relative to the at least 2-dimensions to provide a magnitude enhanced image such that additional levels of magnitudes of the color space dimension are substantially more cognizable to a human eye compared to the 2-dimensional image without the magnitude enhancement analysis;
c) displaying at least a selected portion of the magnitude enhanced image on a display;
d) analyzing the magnitude enhanced image to determine at least one feature of the color space dimension that would not have been cognizable to a human eye without the magnitude enhancement analysis.

31. The method of claim 30 wherein the method further comprises determining an optical density of at least one object in the image.

32. The method of claim 30 wherein the object is breast tissue.

33. The method of claim 30 wherein the magnitude enhancement analysis is a dynamic magnitude enhancement analysis.

34. The method of claim 33 wherein the dynamic analysis comprises at least rolling, tilting and panning the image.

35. Computer-implemented programming that performs the automated elements of the method of claim 1.

36. A computer comprising computer-implemented programming that performs the automated elements of the method of claim 1.

37. The computer of claim 36 wherein the computer comprises a distributed network of linked computers.

38. (canceled)

39. (canceled)

40. A networked computer system comprising computer-implemented programming that performs the automated elements of the method of any one of claims 1.

41. (canceled)

42. (canceled)

43. Computer-implemented programming that performs the automated elements of the method of any one of claims 16.

44. Computer-implemented programming that performs the automated elements of the method of any one of claims 30.

45. A computer comprising computer-implemented programming that performs the automated elements of the method of any one of claims 16.

46. A computer comprising computer-implemented programming that performs the automated elements of the method of any one of claims 30.

47. The computer of claim 45 wherein the computer comprises a distributed network of linked computers.

48. The computer of claim 46 wherein the computer comprises a distributed network of linked computers.
